(19) United States
(12) Patent Application Publication
(10) Pub. No.: US 2011/0250796 A1
(43) Pub. Date: Oct. 13, 2011

(54) CABLE ASSEMBLY WITH IMPROVED TERMINATING MEANS

(75) Inventors: PING-SHENG SU, New Taipei (TW); XIAO-LI LI, Kunshan (CN)

(73) Assignee: HON HAI PRECISION INDUSTRY CO., LTD., New Taipei (TW)

(21) Appl. No.: 13/081,507

(22) Filed: Apr. 7, 2011

(30) Foreign Application Priority Data
Apr. 7, 2010 (CN) 201020151888.6

(51) Int. Cl. H01R 24/00

(52) U.S. Cl. 439/660

(57) ABSTRACT

A cable assembly (1000) includes an insulative housing (11); a cable (14) having an insulative jacket (143) and a plurality of wires (141) enclosed by the insulative jacket; a plurality of contacts (13) mounted to the insulative housing, and each of the contacts having a retention portion, a mating portion and a tail portion, the tail portion (1313) having a taper end (1316) and at least one barb (1317) formed on the tail portion and located adjacent to the taper end, the tail portion inserted into a corresponding wire along an axial direction.

### BACKGROUND OF THE INVENTION

1. Field of the Invention

The present invention relates to a cable assembly, especially to a cable assembly with improved terminating means. The application is related to a copending application having the same title, the same filing date, the same inventors, the same assignee with the instant application.

2. Description of Related Art

A cable assembly generally refers to a cable connected to a connector. The connector includes an insulative housing, a plurality of contacts mounted to the insulative housing and a cable having a number of wires with inner conductors respectively soldered to the contacts.

However, there are some problems of terminating the wires to the contacts by soldering process. First, the cable should be trimmed, i.e. a front part of a jacket of the cable should be removed away to expose the wires, and then an insulator outside of the corresponding wire should be stripped off so as to expose the inner conductors outside, and then the wires also should be organized as they are always in a mess state. It takes much time to terminate the wires to the contacts by soldering process. In addition, the soldering process may cause environment pollution.

Hence, an improved means for terminating the wires to the contacts is required to overcome the problems of the prior art.

### SUMMARY OF THE INVENTION

An object of the present invention is to provide terminating means for a cable assembly without soldering process.

Accordingly, to achieve above-mentioned object, a cable assembly comprises an insulative housing; a cable having an insulative jacket and a plurality of wires enclosed by the insulative jacket; a plurality of contacts mounted to the insulative housing, and each of the contacts having a retention portion, a mating portion and a tail portion, the tail portion having a taper end and at least one barb formed on the tail portion and located adjacent to the taper end, the tail portion inserted into a corresponding wire along an axial direction.

The detailed features of the present invention will be apparent in the detailed description with appropriate reference to the accompanying drawings.

### BRIEF DESCRIPTION OF THE DRAWINGS

FIG. 1 is an assembled, perspective view of a cable assembly of in accordance with the present invention;

FIG. 2 is an exploded, perspective view of the cable assembly in FIG. 1;

FIG. 3 is similar to FIG. 2, but viewed from other aspect;

FIG. 4 is an enlarged view of the contacts; and

FIG. 5 is a cross-section view of the FIG. 1 taken along a line 5-5.

### DETAILED DESCRIPTION OF THE INVENTION

Reference will now be made in detail to the preferred embodiment of the present invention.

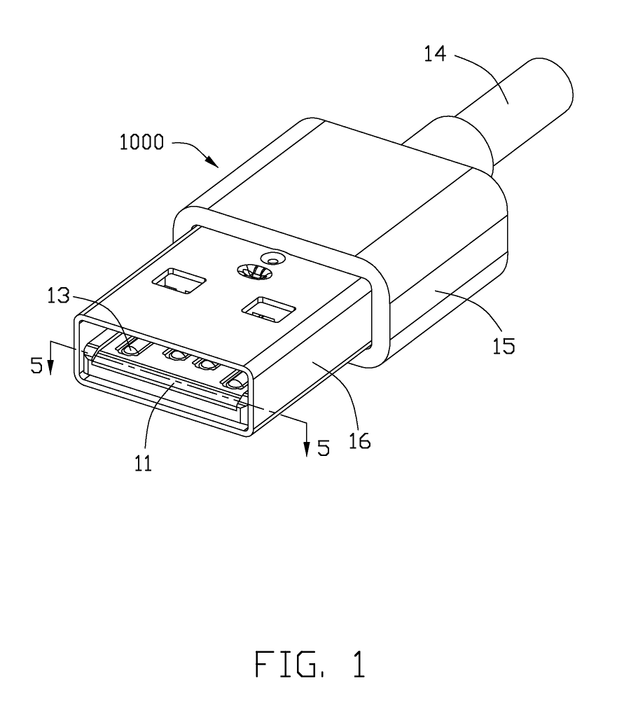

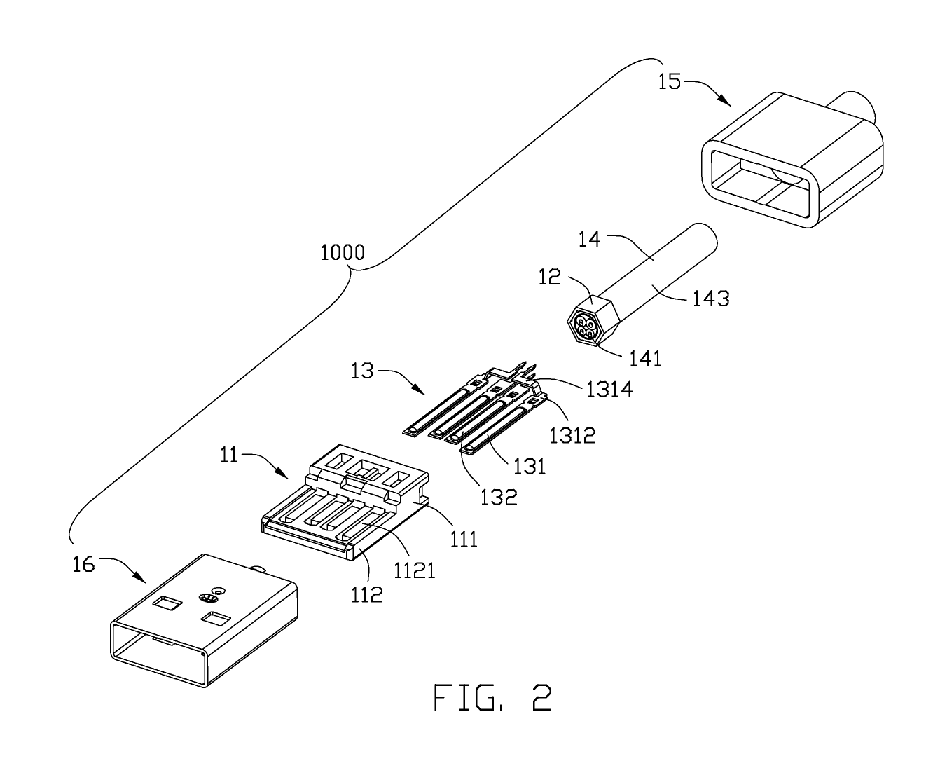

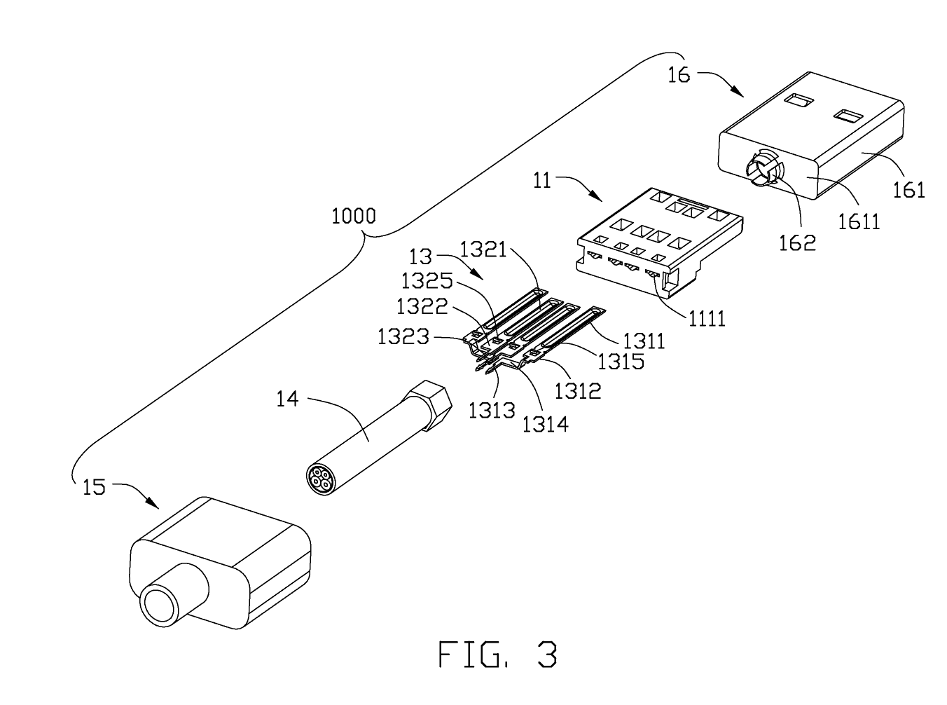

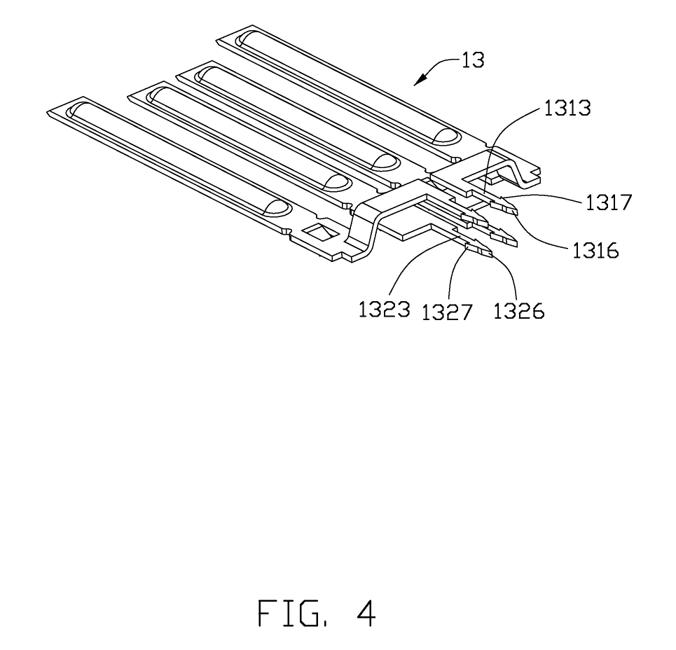

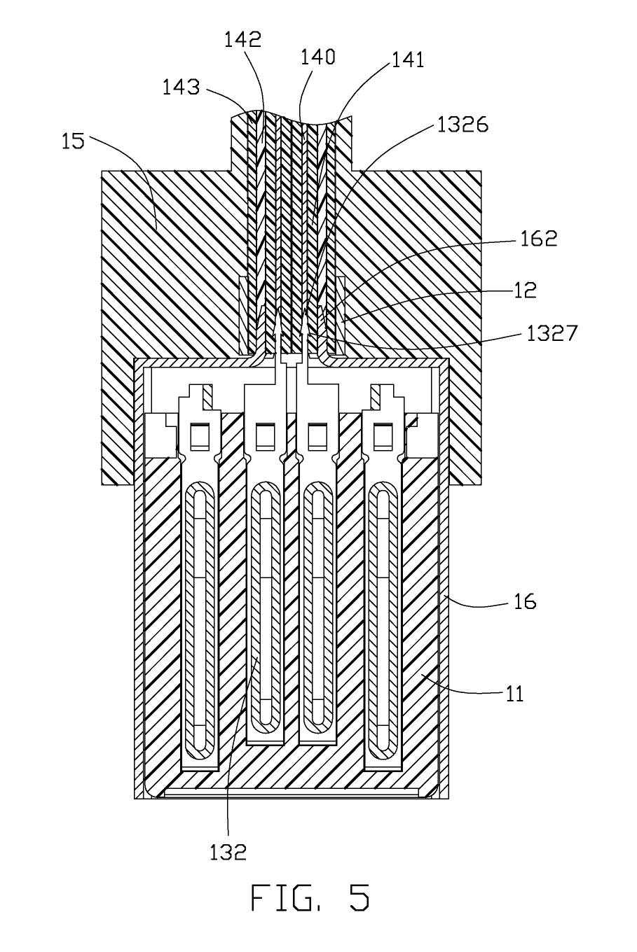

Referring to FIGS. 1-5, a cable assembly 1000 in accordance with the present invention is compatible with Universal Serial Bus (USB). The cable assembly 1000 includes an insulative housing 11, a ferrule 12, a plurality of contacts 13, a cable 14, an insulative cover 15 and a metallic shell 16.

The insulative housing 11 has a base portion 111 and a tongue portion 112 extending forwardly from the base portion 111. The base portion 11 is thicker than the tongue portion 112. There are a number of slots 1111 defined in the base portion and extending along a front-back-direction. Also, a number of grooves 1121 are located in a top side of the tongue portion 112 and align with the slots 1111, respectively. Both the slots 1111 and the grooves 1121 are arranged in a row along a transversal direction.

There are four contacts 13 in the embodiment. Two first contacts 131 are disposed at opposite sides and two second contacts 132 located between the two first contacts 131. Each first contact 131 has a retention portion 1312, a mating portion 1311 extending forwardly from the retention portion 1312, a L-shaped mediate portion 1314 raised from a back portion of the retention portion 1312 and extending inwardly therefrom, and a tail portion 1313 extending backwardly from an end of the mediate portion 1314. The tail portion 1313 has a taper/sharp free end 1316. There are two barbs 1317 formed at two opposite sides of the tail portion 1313 and located adjacent to the taper/sharp free end 1316. Therefore, the tail portion 1313 is of arrow contour. Each second contact 132 has a retention portion 1322, a mating portion 1321 extending forwardly from the retention portion 1322, and a tail portion 1323 extending backwardly from an end of the retention portion 1322. The tail portion 1323 has a taper/sharp free end 1326. There are two barbs 1327 formed at two opposite sides of the tail portion 1323 and located adjacent to the taper/sharp free end 1326. Therefore, the tail portion 1313 is of arrow contour. In addition, there is a tab 1315/1325 upwardly projects from the retention portion 1312/1322. Two tail portions 1313 of the two first contacts 131 are disposed adjacent to each other and arranged at a first level. Two tail portions 1323 of the two second contacts 132 are disposed adjacent to each other and arranged at a second level which is under the first level. A distance between the tail portions 1313 of the first contacts 131 is equal to a distance between the tail portions 1323 of the second contacts 132. Of course, the number of the first contacts 131 and the second contacts 132 may be more than two. By such arrangement, tail portions 1313/1323 are compact. The contacts 13 are assembled to the insulative housing 11 along a front-to-back direction, with the mating portion 1311/1321 accommodated in the corresponding groove 1121, the retention portion 1312/1322 inferentially received in the corresponding slot 1111, and the tail portion 1313/1323 disposed behind the base portion 111 of the insulative housing 11.

The cable 14 is a round type cable, which includes four wires 141, a metallic braiding 142 enclosing the wires 141 and an insulative jacket 143 enclosing the metallic braiding 142. Each wire 141 has an inner conductor with a layer of outer insulator.

The metallic shell 16 has a rectangular shaped frame portion 161 and a cylindrical shaped extension portion 162 projecting backwardly from the frame portion 161.

When assembly, the insulative housing 11 is mounted into the frame portion 161 and the tail portions 1313, 1323 are disposed in the extension portion 162, then by adjusting the cable 16 and having the wires 141 aligning with the tail portions 1313/1323 along an axial direction, pushing the insulative housing 11 backwardly movement to let the tail portions 1313, 1323 inserting/penetrating into the wires 141 along the axial direction of the cable 14, thus the tail portions 1313, 1323 respectively contacting with the inner conductors of the wires 141 to form electrical connection therebetween. In addition, the barb 1317/1327 is also hooked with the corresponding wire 141. The extension portion 162 is inserted between the metallic braiding 142 and the insulative jacket 143. The ferrule 12 is mounted/crimped to an outside of the insulative jacket 143 to squeeze the extension portion 162 and the metallic braiding 142 so as to retain the tail portions 1313, 1323 and the wires 141. Finally, the insulative cover 15 is molded over a back segment of the metallic shell 16, a front segment of the cable 14 and the ferrule 12.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A cable assembly, comprising:
an insulative housing;
a cable having an insulative jacket and a plurality of wires enclosed by the insulative jacket;
a plurality of contacts mounted to the insulative housing, and each of the contacts having a retention portion, a mating portion and a tail portion, the tail portion having a taper end and at least one barb formed on the tail portion and located adjacent to the taper end, the tail portion inserted into a corresponding wire along an axial direction.

2. The cable assembly as claimed in claim 1, wherein there are two of the barbs respectively formed at opposite sides of the tail portion.

3. The cable assembly as claimed in claim 1, wherein the barb hooks with the corresponding wire.

4. The cable assembly as claimed in claim 1, wherein there is a ferrule crimped to the insulative jacket to retain the wires and the tail portions therein.

5. The cable assembly as claimed in claim 5, wherein the barb is enclosed by the ferrule.

6. The cable assembly as claimed in claim 1, wherein the contacts includes first contacts and second contacts, and the mating portions of the first contacts and second contacts are arranged in a row, and the tail portions of the first contacts and the second contacts are spaced from each other along a vertical direction.

7. The cable assembly as claimed in claim 6, wherein there are two first contacts and two second contacts disposed between the two first contacts.

8. The cable assembly as claimed in claim 7, wherein the first contact further has a mediate portion connecting the retention portion and the tail portion.

9. The cable assembly as claimed in claim 8, wherein the mediate portion extends upwardly and inwardly from the retention portion.

10. The cable assembly as claimed in claim 1, wherein the cable further includes a metallic braiding enclosing the wires and within the insulative jacket.

11. The cable assembly as claimed in claim 10, wherein there is a metallic shell which includes a rectangular shaped frame portion enclosing the insulative housing and a cylindrical shaped extension portion projecting backwardly from the frame portion inserted between the insulative jacket and the metallic braiding.

12. The cable assembly as claimed in claim 1, wherein the cable is a round type cable.

13. A cable assembly, comprising:
an insulative housing;
a cable having an insulative jacket and a plurality of wires enclosed by the insulative jacket;
a plurality of contacts mounted to the insulative housing, and each of the contacts having a retention portion, a mating portion and a tail portion;
wherein the tail portion is arrow contour and inserted into a corresponding wire along an axial direction and hooked with the corresponding wire.

14. The cable assembly as claimed in claim 13, wherein there is a ferrule crimped to the insulative jacket to squeeze the wire and the tail portion.

15. A cable connector assembly comprising:
an insulative housing;
a metallic shell enclosing said housing to commonly defining a mating port;
a plurality of contacts disposed in the housing with contacting sections exposed in the mating port and spanned in a transverse direction and tail sections arranged in a bundle manner;
a cable including a plurality of wires in a bundle manner under condition that the tail sections respectively pierce into the corresponding wires axially;
a deformable ferrule crimped upon the cable to enhance retention between the tail section within the corresponding wire.

16. The cable connector assembly as claimed in claim 15, wherein each of said tail sections is equipped with a lateral barb for enhancement of retention with the corresponding wire.

17. The cable connector assembly as claimed in claim 15, wherein the shell includes an extension axially pierces into the cable surrounding the wires.

18. The cable connector assembly as claimed in claim 15, wherein the contacts including lateral outer ones sandwiching lateral inner ones in the transverse direction, and the tail sections of the outer ones are offset from those of the inner ones in a vertical direction perpendicular to said transverse direction.

19. The cable connector assembly as claimed in claim 18, wherein the outer ones include laterally extending connection sections to connect the corresponding tail sections, respectively.

20. The cable connector assembly as claimed 15, wherein an overcoat covers a rear portion of the shell, a front portion of the cable including the ferrule.
